(19) United States
(12) Patent Application Publication
(10) Pub. No.: US 2024/0401480 A1
(43) Pub. Date: Dec. 5, 2024

(54) DIGITAL SPEED REGULATING VALVE FOR ALIGNING HYDRAULIC SUPPORTS IN FULLY MECHANIZED MINING FACE AND CONTROL METHOD THEREOF

(71) Applicant: TAIYUAN UNIVERSITY OF TECHNOLOGY, Taiyuan (CN)

(72) Inventors: Ziming KOU, Taiyuan (CN); Juan WU, Taiyuan (CN); Jiyun ZHAO, Taiyuan (CN); Qichao REN, Taiyuan (CN); Tianyi JIN, Taiyuan (CN); Tengyan HOU, Taiyuan (CN); Peng XU, Taiyuan (CN); Yuchen LI, Taiyuan (CN)

(73) Assignee: TAIYUAN UNIVERSITY OF TECHNOLOGY, Taiyuan (CN)

(21) Appl. No.: 18/259,912

(22) PCT Filed: Oct. 25, 2022
(86) PCT No.: PCT/CN2022/127341

§ 371 Date: Jun. 29, 2023

(30) Foreign Application Priority Data
Apr. 24, 2022 (CN) 202210435122.8

(51) Int. Cl. E21D 23/18; E21D 23/00; E21D 23/14; F15B 13/02; F15B 13/04; F16K 47/08

(52) U.S. Cl. CPC E21D 23/18; F15B 13/025; F15B 13/04; F16K 47/08; E21D 23/0004; E21D 23/14

(57) ABSTRACT

A speed regulating valve, an alignment system, and an alignment method are provided. The speed regulating valve includes a valve core and a valve base. The valve core is provided with an internal channel and is in communication with an inlet of the speed regulating valve. A first speed regulating port is arranged on the valve core. The valve base is in communication with an outlet of the speed regulating valve, and a second speed regulating port is arranged on the valve base. The valve core and the valve base are rotatable relative to each other, and the second speed regulating port is on a trajectory of a rotation of the first speed regulating port.

### CROSS-REFERENCE TO THE RELATED APPLICATIONS

This application is the national phase entry of International Application No. PCT/CN2022/127341, filed on Oct. 25, 2022, which is based upon and claims priority to Chinese Patent Application No. 202210435122.8, filed on Apr. 24, 2022, the entire contents of which are incorporated herein by reference.

### TECHNICAL FIELD

Embodiments of the present application relate to the field of alignment in a fully mechanized mining face, and in particular, to a speed regulating valve, an alignment system, and an alignment method.

### BACKGROUND

The straightness of a hydraulic support in a fully mechanized mining face directly affects the working efficiency of the whole fully mechanized mining face. At present, the alignment of the hydraulic supports in the fully mechanized mining face of coal mines is to adjust the movement of the hydraulic support through a large-flow electro-hydraulic reversing valve or manual-operated valve, and the discontinuous change of the opening degree of such valves causes impact on hydraulic components of the hydraulic support. According to “General technical specifications for smart mine information systems”, it is not expected to manually adjust the straightness of the hydraulic support in the continuous advancing process of the fully mechanized mining face. Therefore, a speed regulating valve is urgently needed to continuously adjust the flow rate of emulsion, so as to precisely adjust the position of the hydraulic support and reduce the impact of emulsion on the alignment system during the alignment process.

### SUMMARY

In order to solve the above problems, embodiments of the present application provide a speed regulating valve, an alignment system, and an alignment method, which have the advantage of precisely controlling a flow rate of an emulsion to precisely adjust the position of the hydraulic support, thereby reducing the impact of the emulsion on the alignment system during adjustment.

To achieve the above objective, technical solutions of the present application are implemented as follows.

According to a first aspect, an embodiment of the present application provides a speed regulating valve, including: a valve core and a valve base, where, the valve core is provided with an internal channel and is in communication with an inlet of the speed regulating valve, and a first speed regulating port is arranged on the valve core; and the valve base is in communication with an outlet of the speed regulating valve, and a second speed regulating port is arranged on the valve base. The valve core and the valve base are rotatable relative to each other, and the second speed regulating port is on a trajectory of a rotation of the first speed regulating port. When the valve core and the valve base rotate relative to each other, the first speed regulating port and the second speed regulating port are gradually aligned to communicate the inlet and the outlet of the speed regulating valve; and
a fixed differential pressure reducing device is arranged between the inlet of the speed regulating valve and the valve core, the fixed differential pressure reducing device is provided with a sealing part, one end of the sealing part is in communication with the inlet of the speed regulating valve, and an other end of the sealing part is in communication with the outlet of the speed regulating valve, to balance a pressure difference between the outlet and the inlet of the speed regulating valve.

According to the speed regulating valve provided in the embodiment of the present application, when the valve core and the valve base rotate relative to each other, the first speed regulating port on the valve core and the second speed regulating port on the valve base experience a slow and gradual alignment process, so that a flow area of a flow channel formed between the first speed regulating port and the second speed regulating port is gradually changed. When the first speed regulating port and the second speed regulating port are misaligned, the speed regulating valve is correspondingly in a closed state, and a flow rate of an emulsion passing through the speed regulating valve is zero. When the valve core and the valve base rotate relative to each other so that the first speed regulating port and the second speed regulating port are completely aligned, the speed regulating valve is correspondingly in a fully opened state, and the flow rate of the emulsion passing through the speed regulating valve is a maximum. By controlling a relative speed of a rotation between the valve core and the valve base, the flow rate of the emulsion passing through the speed regulating valve is precisely controlled. Based on this, an action time of the speed regulating valve is controlled to precisely control a total volume of the emulsion passing through the speed regulating valve. Whereby, a position of a hydraulic support is precisely adjusted. Moreover, during the rotation of the valve core and the valve base relative to each other, the flow rate of the emulsion gradually changes from zero to the maximum, and the change of the flow rate of the emulsion is relatively slow, thereby reducing an impact of the emulsion on an alignment system during an adjustment process.

In a possible implementation of the present application, the valve core is of a cylindrical structure, a hollow structure is arranged at one end of the valve core close to the inlet of the speed regulating valve, a cylindrical cavity is arranged at a position on the valve base corresponding to the valve core, and the valve core is sheathed in the cylindrical cavity.

In a possible implementation of the present application, the first speed regulating port is a circular hole, and an axis of the first speed regulating port is perpendicular to an axis of the valve core.

In a possible implementation of the present application, a plurality of the first speed regulating ports are arranged, and the plurality of the first speed regulating ports are evenly distributed along a circumferential direction of the valve core.

In a possible implementation of the present application, when the valve core rotates along the valve base, only one of the first speed regulating ports is in communication with the second speed regulating port.

In a possible implementation of the present application, a driving part is arranged at a position of the speed regulating valve corresponding to the valve core, and the driving part is in a transmission connection with the valve core to rotate the valve core.

According to a second aspect, an embodiment of the present application provides an alignment system, including hydraulic supports, an oil supply device, and the speed regulating valve provided in the first aspect, where, a number of the hydraulic supports is N, the N hydraulic supports are arranged and distributed along a first direction, N≥2, N is a positive integer, the hydraulic supports are provided with a pedestal, and a push hydraulic jack is arranged on one side of the pedestal along a second direction; and the oil supply device is configured to provide the emulsion, and is connected to the push hydraulic jack through the speed regulating valve.

Since the alignment system provided in the embodiment of the present application includes the speed regulating valve provided in the first aspect, the same technical effect can be achieved: precisely controlling the flow rate of the emulsion to precisely adjust the position of the hydraulic support, thereby reducing the impact of the emulsion on the alignment system during the adjustment.

In a possible implementation of the present application, a top beam is arranged above the pedestal, lifting hydraulic jacks are arranged between the pedestal and the top beam, and laser sensors are arranged on two sides of the lifting hydraulic jacks of a first hydraulic support and an N^{th} hydraulic support.

In a possible implementation of the present application, the laser sensors are arranged on the two sides of the lifting hydraulic jacks along the second direction and are at a same distance from the lifting hydraulic jacks.

In a possible implementation of the present application, the laser sensors arranged on the first hydraulic support and the N^{th} hydraulic support are staggered along a third direction, so that the laser sensors do not interfere with each other.

According to a third aspect, an embodiment of the present application provide an alignment method, which is implemented by the alignment system provided in the second aspect and includes: adjusting a relative rotation speed and displacement of the valve core and the valve base of the speed regulating valve provided in the first aspect, to adjust an opening speed, a closing speed, and/or an opening degree of the speed regulating valve to adjust a flow rate of the emulsion, so as to adjust the position of the hydraulic support.

In a possible implementation of the present application, sensors are arranged on the two sides of the lifting hydraulic jacks of the first hydraulic support and the N^{th} hydraulic support, the sensors are arranged along the second direction, the sensors are at a same distance from the lifting hydraulic jacks, and the sensors are configured to determine relative positions of the hydraulic supports.

In a possible implementation of the present application, the alignment method provided in the embodiment of the present application includes the following steps:

step S01: a first alignment stage: opening the speed regulating valve to a fully opened state at a first speed, to adjust a position of an n^{th} hydraulic support, and when the position of the n^{th} hydraulic support is detected by the sensors, closing the speed regulating valve to a fully closed state at the first speed, to stop the n^{th} hydraulic support at a first position, where 2≤n≤N−1;

step S02: a second alignment stage: determining position information of the first position by the sensors, generating a second speed by a controller according to the position information of the first position, and allowing the speed regulating valve to operate at the second speed to adjust the position of the n^{th} hydraulic support; and

step S03: repeating the steps S01 to S02, to adjust positions of a second hydraulic support to an (N−1)^{th} hydraulic support.

Since the alignment method provided in the embodiment of the present application is implemented by using the alignment system provided in the second aspect, the same technical effect can be achieved: precisely controlling the flow rate of the emulsion to precisely adjust the positions of the hydraulic supports, thereby reducing the impact of the emulsion on the alignment system during the adjustment.

### BRIEF DESCRIPTION OF THE DRAWINGS

FIG. 1 is a schematic structural diagram of a speed regulating valve according to an embodiment of the present application;

FIG. 2 is a schematic cross-sectional view of a speed regulating valve according to an embodiment of the present application;

FIG. 3 is a schematic layout view of an alignment system according to an embodiment of the present application;

FIG. 4 is a schematic diagram showing oil passage connection of an electro-hydraulic conversion module, a speed regulating valve, and a push hydraulic jack of an alignment system according to an embodiment of the present application;

FIG. 5 is a schematic diagram showing the relationship between the moving speed of a piston of a push hydraulic jack and time during first-stage adjustment in an alignment method according to an embodiment of the present application;

FIG. 6 is a schematic diagram of a relative position of a hydraulic support and an opening degree of a speed regulating valve during first-stage adjustment in an alignment method according to an embodiment of the present application;

FIG. 7 is a schematic diagram of a second speed during second-stage adjustment in an alignment method according to an embodiment of the present application;

FIG. 8 is a schematic diagram of classification of position deviations of a displacement hydraulic support and a reference hydraulic support in an alignment method according to an embodiment of the present application;

FIG. 9 is a schematic signal flowchart of an alignment method according to an embodiment of the present application; and

FIG. 10 is a schematic flowchart of a fuzzy controller in an alignment method according to an embodiment of the present application.

### LIST OF REFERENCE NUMERALS

1—speed regulating valve; 2—valve core; 21—internal channel; 22—first speed regulating port; 3—valve base; 31—second speed regulating port; 4—inlet of speed regulating valve; 5—driving part; 51—stepping motor; 52—coupling; 53—mounting base; 6—fixed differential pressure reducing device; 61—spring; 62—piston; 63—guide column; 631—first guide column; 632—second guide column; 633—first damping hole; 634—buffer hole; 635—second damping hole; 64—reduced structure; 7—hydraulic support; 71—first hydraulic support; 711—pedestal; 712—push hydraulic jack; 713—top beam; 714—lifting hydraulic jack; 715—laser sensor; 7151—first laser sensor; 7152—second laser sensor; 7153—third laser sensor; 7154—fourth laser sensor; 716—electro-hydraulic conversion module; 72—N^{th} hydraulic support; 73—reference hydraulic support; 74—displacement hydraulic support; 8—control box; 81—power supply; 82—upper computer; 83—controller; 9—wireless laser displacement sensor.

### DETAILED DESCRIPTION OF THE EMBODIMENTS

To make the objectives, technical solutions and advantages of the present application clearer, specific technical solutions of the present application will be described in further detail below with reference to the accompanying drawings in the embodiments of the present application. The following examples are intended to illustrate the present application, instead of limiting the scope of the present application.

In the embodiments of the present application, the terms “first” and “second” are used herein for purposes of description, and are not intended to indicate or imply relative importance or implicitly point out the number of the indicated technical feature. Therefore, the features defined by “first”, and “second” may explicitly or implicitly include one or more features. In the description of the embodiments of the present application, “multiple” and “a plurality of” mean two or more, unless otherwise particularly defined.

In addition, in the embodiments of the present application, directional terms such as “up”, “down”, “left”, and “right” are defined with respect to the orientations in which the components are schematically placed in the drawings. It should be understood that such directional terms are relative concepts for description and clarification, and may vary in response to changes in the orientations in which the components are placed in the drawings.

In the embodiments of the present application, unless otherwise clearly specified and defined, the terms “connect” and variants thereof should be interpreted in a broad sense, for example, may be a fixed connection, a detachable connection, or an integral connection; or may be a direct connection, or an indirect connection via an intermediate medium.

In the embodiments of the present application, the terms “comprise”, “include” or any other variants are intended to encompass non-exclusive inclusion, such that a process, a method, an article or an apparatus including a series of elements not only include those elements, but also includes other elements not listed explicitly or includes intrinsic elements for the process, the method, the article, or the apparatus. Without any further limitation, an element defined by the phrase “comprising one” does not exclude existence of other same elements in the process, the method, the article, or the apparatus that includes the elements.

In the embodiments of the present application, the terms such as “exemplary” and “for example” are used as examples, explanations, or illustrations. Any embodiment or design described as “exemplary” or “for example” in the embodiments of the present application should not be construed as being superior or advantageous over other embodiments or designs. Rather, the use of the terms such as “exemplary” and “for example” is intended to present the relevant concepts in a concrete manner.

Embodiments of the present application provide an alignment system. The alignment system is used for adjusting the straightness of a fully mechanized mining face. With the mining of a coal wall, it is necessary to move hydraulic supports toward the coal wall. The alignment system includes N hydraulic supports. The N hydraulic supports are arranged along an extending direction of the coal wall (first direction). The hydraulic supports are provided with a pedestal. A push hydraulic jack is arranged along an extending direction of the pedestal toward the coal wall (second direction). An emulsion is respectively introduced into two sides of a piston of the push hydraulic jack to cause a main shaft of the push hydraulic jack to extend out or retract, to change the position of the hydraulic support. In order to control the push hydraulic jack of the hydraulic support, the alignment system further includes a speed regulating valve. By adjusting the opening degree of the speed regulating valve, the flow rate of emulsion flowing to the push hydraulic jack through the speed regulating valve can be adjusted, so that the displacement of the push hydraulic jack can be adjusted.

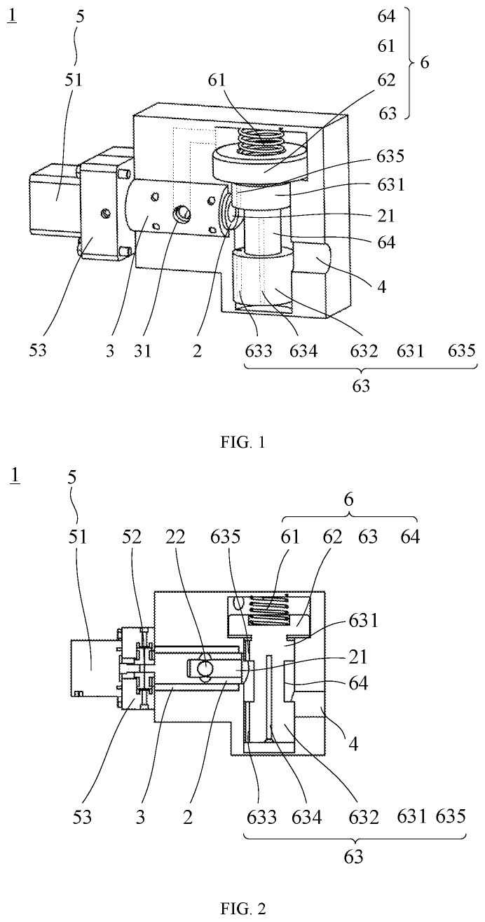

According to a first aspect, referring to FIG. 1 and FIG. 2, an embodiment of the present application provides a speed regulating valve 1, including a valve core 2 and a valve base 3. The valve core 2 is provided with an internal channel 21 and is in communication with an inlet 4 of the speed regulating valve, and a first speed regulating port 22 is arranged on the valve core 2. The valve base 3 is in communication with an outlet of the speed regulating valve, and a second speed regulating port 31 is arranged on the valve base 3. The valve core 2 and the valve base 3 are rotatable relative to each other, and the second speed regulating port 31 is on a trajectory of a rotation of the first speed regulating port 22. When the valve core 2 and the valve base 3 rotate relative to each other, the first speed regulating port 22 and the second speed regulating port 31 are gradually aligned to communicate the inlet 4 of the speed regulating valve and the outlet of the speed regulating valve. FIG. 1 and FIG. 2 are cross-sectional views of the speed regulating valve 1. The outlet of the speed regulating valve is arranged on the valve body corresponding to the second speed regulating port 31, and is not shown.

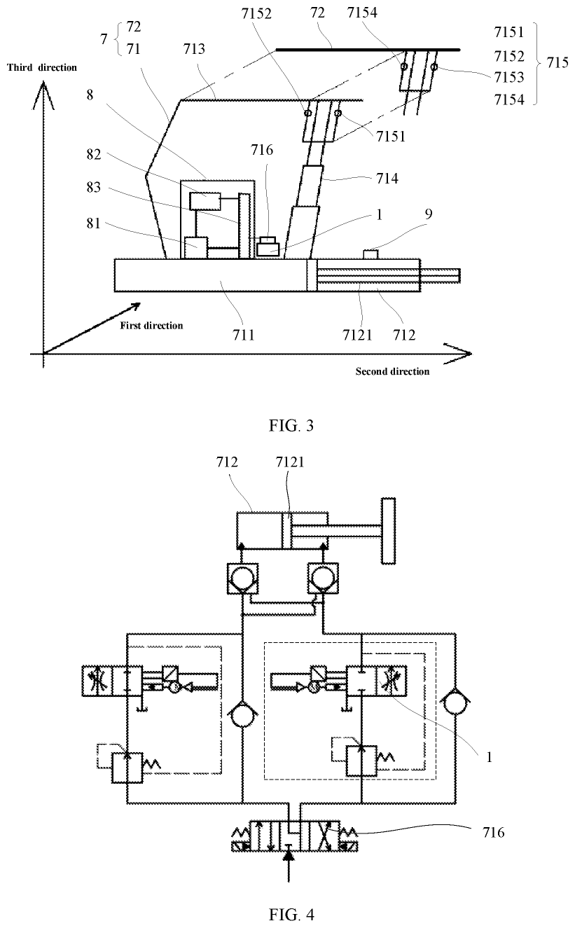

According to the speed regulating valve 1 provided in the embodiments of the present application, the relative positions of the valve core 2 and the valve base 3 are changed through the relative rotation of the valve core 2 and the valve base 3. The first speed regulating port 22 is arranged on the valve core 2. The valve core 2 is provided with the internal channel 21. The inlet 4 of the speed regulating valve is in communication with the first speed regulating port 22 through the internal channel 21. Correspondingly, the second speed regulating port 31 is arranged on the valve base 3, the second speed regulating port 31 is arranged on the trajectory of a rotation of the first speed regulating port 22, and the second speed regulating port 31 is in communication with the outlet of the speed regulating valve. In this way, when the valve core 2 and the valve base 3 rotate relative to each other, the first speed regulating port 22 and the second speed regulating port 31 experience a slow and gradual alignment process, so that an area of a flow channel between the inlet 4 of the speed regulating valve and the outlet of the speed regulating valve is slowly changed, and the flow rate of the emulsion is changed slowly and gradually from zero when the first speed regulating port 22 and the second speed regulating port 31 are misaligned to a maximum flow rate when the first speed regulating port 22 and the second speed regulating port 31 are aligned, that is, the opening degree of the speed regulating valve 1 is gradually increased. Referring to FIG. 3, because the speed regulating valve 1 provided in the embodiments of the present application can gradually and continuously adjust the flow rate of the emulsion from zero, the main shaft of the push hydraulic jack 712 can be slowly changed, thereby precisely adjusting the position of the hydraulic support 7 and reducing the impact of the emulsion during the adjustment process. It should be noted that in the embodiments of the present application, the emulsion is not limited, as long as a hydraulic effect can be provided for the push hydraulic jack 712. For example, the emulsion may be a lubricant, high-pressure fire-resistant oil, anti-wear emulsion, etc. In this embodiment, the shapes of the first speed regulating port 22 and the second speed regulating port 31 are not limited, and may be square, elliptical or circular, as long as the gradual alignment of the first speed regulating port 22 and the second speed regulating port 31 causes the flow channel formed by the first speed regulating port 22 and the second speed regulating port 31 to change slowly and continuously. In the embodiments of the present application, the shapes of the valve core 2 and the valve base 3 are also not limited, as long as the valve core 2 can rotate relative to the valve base 3. For example, the valve core 2 may be in the shape of a cone, a cylinder or a sphere, and a corresponding cavity is provided on the valve base 3 for the valve core 2 to rotate therein.

Referring to FIG. 1 and FIG. 2, preferably, in a possible implementation of the present application, the valve core 2 is of a cylindrical structure. A hollow structure is arranged at one end of the valve core 2 close to the inlet 4 of the speed regulating valve to serve as the internal channel 21. A cylindrical cavity is arranged at a position of the valve base 3 corresponding to the valve core 2, and the valve core 2 is sheathed in the cylindrical cavity. The configuration of the valve core 2 into a cylindrical structure facilitates processing and is easy to realize, and processing requirements can be met by using ordinary lathe equipment. Correspondingly, the cylindrical cavity of the valve base 3 is also easy to process, thereby reducing the requirement for processing equipment and making it easy to obtain the valve core 2 and the valve base 3 of the speed regulating valve 1 provided in the embodiments of the present application. In addition, it should be noted that in the embodiments of the present application, the appearance structure of the valve base 3 is not limited, as long as a cylindrical cavity corresponding to the valve core 2 is arranged inside the valve base 3. The valve base 3 may be configured into a cylindrical structure, or may be configured into other structures, such as a cuboid structure, which is not limited in the embodiments of the present application.

Based on this, the first speed regulating port 22 is a circular hole, and an axis of the first speed regulating port 22 is perpendicular to an axis of the valve core 2. The most commonly used method is to configure the first speed regulating port 22 as a circular hole, which may be conveniently formed using a drill bit. When the first speed regulating port 22 is formed using a drill bit, the axis of the first speed regulating port 22 can be easily made perpendicular to the axis of the valve core 2. The first speed regulating port 22 can be formed using a bench drill.

In addition, in a possible implementation of the present application, a plurality of the first speed regulating ports 22 are arranged on the valve core 2, and the plurality of the first speed regulating ports 22 are evenly distributed along a circumferential direction of the valve core 2. Through the arrangement of the plurality of the first speed regulating ports 22, the first speed regulating ports 22 can be aligned with the second speed regulating ports 31 several times during one rotation cycle of the valve core 2, so that the speed regulating valve 1 can have a plurality of closed and open states, thereby improving the efficiency of the speed regulating valve 1. In addition, through the uniform distribution of the plurality of the first speed regulating ports 22 along the circumferential direction of the valve core 2, the alignment state of the first speed regulating ports 22 and the second speed regulating port 31 can form a repeated cycle relationship with the rotation time of the valve core 2, making it more convenient to control the speed regulating valve 1.

In another possible implementation of the present application, the second speed regulating port 31 is also a circular hole, and when the valve core 2 rotates along the valve base 3, only one of the first speed regulating ports 22 is in communication with the second speed regulating port 31. The configuration of the second speed regulating port 31 in a circular shape is easiest to implement, and also facilitates the alignment with the first speed regulating ports 22. An axis of the second speed regulating port 31 is arranged perpendicular to an axis of the cylindrical cavity of the valve base 3. In this way, the processing of the second speed regulating port 31 can be easily realized, and when the first speed regulating port 22 and the second speed regulating port 31 are aligned, the flow channel formed between the first speed regulating port 22 and the second speed regulating port 31 extends in a straight line, so that the flow resistance is small and the pressure loss of the emulsion can be reduced.

Further, referring to FIG. 1, FIG. 2, and FIG. 3, a driving part 5 is arranged at a position of the speed regulating valve 1 corresponding to the valve core 2, and the driving part 5 is in a transmission connection with the valve core 2. The driving part 5 may be a motor actuator or a pneumatic actuator. The pneumatic actuator requires a matching air compressor and a corresponding air storage system, and the cost is relatively high. However, even when a power supply 81 fails, the speed regulating valve 1 can be controlled by compressed air in the air storage system. The motor actuator is relatively simple, and is also easy to control. Particularly when a stepping motor 51 is used, the stepping motor 51 can be controlled by setting different parameters using a controller 83, thereby controlling the speed regulating valve 1. For example, a program may be set in advance to rotate the stepping motor 51 at a predetermined speed, to rotate the valve core 2 of the speed regulating valve 1 at the same speed, thereby realizing the precise control of the speed regulating valve 1. Based on this, a coupling 52 may be arranged between the stepping motor 51 and the valve core 2 to transmit a torque of the stepping motor 51 to the valve core 2. An elastic coupling may be arranged to mitigate the impact generated when the stepping motor 51 is started. Commonly used elastic couplings include a serpentine spring coupling, a diaphragm coupling, a pin-type elastic coupling or a coupling with an elastic spider. The type of the coupling 52 is not limited in the embodiments of the present application. In order to limit the swing of the valve core 2 when rotating, a bearing may further be arranged between the valve core 2 and the valve body. In this way, the friction between the valve core 2 and the valve body can also be reduced. Referring to FIG. 1 and FIG. 2, a mounting base 53 is further arranged between the stepping motor 51 and the valve body. The mounting base 53 is fixed to the valve body by a connecting bolt. The stepping motor 51 is fixed to the mounting base 53 by a connecting bolt. In this way, the coupling 52 can be arranged in the mounting base 53, the processing of the valve body is avoided, the structure of the valve body is kept simple, and the sealing structure between the valve core 2 and the valve body can be well arranged, to prevent the leakage of the emulsion in the speed regulating valve 1.

When the speed regulating valve 1 is fully closed, there is a large pressure difference between the outlet of the speed regulating valve and the inlet 4 of the speed regulating valve. In this case, a large torque is required for rotating the valve core 2. In order to balance the pressure difference between the outlet of the speed regulating valve and the inlet 4 of the speed regulating valve, a fixed differential pressure reducing device 6 is arranged between the outlet of the speed regulating valve and the inlet 4 of the speed regulating valve. There are also many options for the configuration of the fixed differential pressure reducing device 6. For example, referring to FIG. 1 and FIG. 2, a spring 61 is arranged in the valve body, one end of the spring 61 is connected to the valve body, and a piston 62 is arranged at the other end of the spring 61. One end of the piston 62 close to the spring 61 is in communication with the outlet of the speed regulating valve, and one end of the piston 62 distant from the spring 61 is in communication with the inlet 4 of the speed regulating valve. The outlet of the speed regulating valve and the inlet 4 of the speed regulating valve are isolated by the piston 62. In this way, the pressure between the outlet of the speed regulating valve and the inlet 4 of the speed regulating valve can be transmitted through the piston 62, to reduce the pressure difference between the outlet of the speed regulating valve and the inlet of the speed regulating valve.

Referring to FIG. 1 and FIG. 2, it should be noted that a guide column 63 is arranged extending on one side of the piston 62 distant from the spring 61, a guide groove is provided at a position of the valve body corresponding to the guide column 63, and a gap between the guide column 63 and the guide groove is relatively small and limits the sliding direction of the guide column 63, so that the guide column 63 slides along the guide groove, thereby limiting the sliding direction of the piston 62. Referring to FIG. 1 and FIG. 2, the fixed differential pressure reducing device 6 is arranged in a direction perpendicular to an extending direction of the valve core 2, so that the speed regulating valve 1 can be compact in structure and small in volume.

Based on this, a reduced structure 64 is arranged at a position of the guide column 63 close to the valve core 2, so that the passage through which the emulsion flows to the valve core 2 is kept unblocked, and the guide column 63 is divided into a first guide column 631 and a second guide column 632. The first guide column 631 is close to the spring 61. A first damping hole 633 is formed through an edge of the second guide column 632, and the lower part of the second guide column 632 is filled with emulsion. When the guide column 63 slides downward, the flow rate of the emulsion passing through the first damping hole 633 is small, which can slow down the movement speed of the guide column 63 and play a damping role, and can also serve as a flow channel for the emulsion to flow through the upper and lower sides of the guide column 63. In addition, a buffer hole 634 is provided in the middle of the second guide column 632, to provide a predetermined buffer effect. It should be noted that a second damping hole 635 is also formed through an edge of the second guide column 632. The second damping hole 635 also provides a damping effect, and can also serve as a flow channel for the emulsion to flow through upper and lower sides of the guide column 532.

It should be noted that, when the pressure at the outlet of the speed regulating valve is high, the piston 62 slides toward the inlet 4 of the speed regulating valve, and at the same time, the first guide column 631 also slides toward the inlet 4 of the speed regulating valve and blocks an entrance of the internal channel 21 of the speed regulating valve 1, so that the emulsion before the entrance of the internal channel 21 builds the pressure, to increase the pressure of the emulsion before the entrance of the internal channel 21, thereby reducing the pressure difference between the outlet of the speed regulating valve and the entrance of the internal channel 21. When the pressure at the outlet of the speed regulating valve is low, the piston 62 slides toward the spring side of the speed regulating valve to increase the opening to the internal channel 21 to reduce the pressure, thereby reducing the pressure difference between the outlet of the speed regulating valve and the internal channel 21.

According to a second aspect, referring to FIG. 3, an embodiment of the present application provides an alignment system, including: the speed regulating valve 1 provided in the first aspect, a hydraulic support 7, and an oil supply device. The number of hydraulic supports 7 is N, N≥2, N is a positive integer, and the N hydraulic supports 7 are arranged along a first direction. The first direction herein is an extending direction of a coal wall. For convenience of description, the nearest hydraulic support 7 is referred to as the first hydraulic support 71, and the farthest hydraulic support 7 is referred to as the N^{th} hydraulic support 72. It should be noted that, for convenience of illustration, other parts of the N^{th} hydraulic support 72 are not shown in FIG. 3. For other parts of the N^{th} hydraulic support 72, reference may be made to the first hydraulic support 71. The hydraulic supports 7 between the first hydraulic support 71 and the N^{th} hydraulic support 72 are referred to as intermediate hydraulic supports. The hydraulic supports 7 are provided with a pedestal 711, and a push hydraulic jack 712 is arranged on one side of the pedestal 711 along a second direction. The second direction is an extending direction of the pedestal 711 toward the coal wall. The oil supply device provides emulsion for the alignment system. The oil supply device, the speed regulating valve 1, and the push hydraulic jack 712 are connected together by oil pipes. The oil pipes may be high-pressure rubber oil pipes or stainless steel oil pipes. For environments with large vibration, the high-pressure rubber oil pipes can isolate vibration and resist impact. If stainless steel oil pipes are used, expansion joints are generally arranged to isolate vibration between the oil supply device and the oil pipes. The type of the oil pipes is not limited in the embodiments of the present application.

In addition, a top beam 713 is further arranged above the pedestal 711, a lifting hydraulic jack 714 is arranged between the pedestal 711 and the top beam 713, and laser sensors 715 are arranged on two sides of the lifting hydraulic jacks 714 of the first hydraulic support 71 and the N^{th} hydraulic support 72. The laser sensors 715 include a first laser sensor 7151, a second laser sensor 7152, a third laser sensor 7153, and a fourth laser sensor 7154. In this way, the relative positions of the intermediate hydraulic supports can be determined by the laser sensors 715 on the two sides of the lifting hydraulic jacks 714 of the first hydraulic support 71 and the N^{th} hydraulic support 72. The laser sensors 715 may be wireless laser sensors or wired laser sensors. The wireless laser sensors are easy to deploy. The signal transmission of wired laser sensors is stable and reliable. The type of the laser sensors 715 may be selected according to actual situations, and is not limited in the embodiments of the present application. It should be noted that in FIG. 3, for the N^{th} hydraulic support 72, only the main shaft of the lifting hydraulic jack 714 is shown, and other parts are not shown for neatness. The configuration of the N^{th} hydraulic support 72 is the same as that of the first hydraulic support 71, and reference may be made to the configuration of the first hydraulic support 71.

Based on this, referring to FIG. 3, the laser sensors 715 are arranged on two sides of the main shaft of the lifting hydraulic jack 714 along the second direction, and the laser sensors 715 on the two sides are at a same distance from the lifting hydraulic jack 714. By such an arrangement, the position of the intermediate hydraulic support can be determined more accurately when the intermediate hydraulic support is displaced.

Further, the laser sensors 715 arranged on the lifting hydraulic jacks 714 of the first hydraulic support 71 and the N^{th} hydraulic support 72 are staggered along a third direction. Specifically, referring to FIG. 3, the first laser sensor 7151 and the third laser sensor 7153 are at different heights along the third direction, and the second laser sensor 7152 and the fourth laser sensor 7154 are at different heights along the third direction. By such an arrangement, the laser sensors 715 can fully provide their respective functions without interfering with each other. In this way, the relative position of the intermediate hydraulic support can be precisely determined using the plurality of the laser sensors 715, thereby achieving precise control of the displacement of the intermediate hydraulic support.

It should be noted that two ends of a piston 6121 of the push hydraulic jack of the hydraulic support 7 are each provided with an oil passage, so that the main shaft of the push hydraulic jack 712 can be controlled to extend out or retract by introducing emulsion at the two ends of the piston 6121 of the push hydraulic jack. For example, introducing the emulsion to one side of the push hydraulic jack 712 close to the main shaft causes the main shaft to retract; and introducing the emulsion to one side of the push hydraulic jack 712 distant from the main shaft causes the main shaft to extend out. Therefore, the alignment system generally further includes an electro-hydraulic conversion module 716. The electro-hydraulic conversion module 716 may determine to communicate the oil passage to which side of the piston 6121 of the push hydraulic jack, so that the main shaft of the push hydraulic jack 712 can be controlled to extend out or retract. FIG. 4 is a schematic diagram showing oil passage connection of the electro-hydraulic conversion module 716, the speed regulating valve 1, and the push hydraulic jack 712.

In order to facilitate the arrangement of a circuit of the alignment system, referring to FIG. 3, a control box 8 is further arranged on the pedestal 711 of the hydraulic support 7. The control box 8 includes therein: a power supply 81, an upper computer 82, and a controller 83. The control box 8 may also be arranged at other positions according to an actual on-site situation, which is not limited in the embodiments of the present application. The power supply 81 supplies power to the speed regulating valve 1, the electro-hydraulic conversion module 716, and other electric components. The speed regulating valve 1 and the electro-hydraulic conversion module 716 are electrically connected to the controller 83 and can operate according to an instruction signal from the controller 83. The laser sensor 715 is also electrically connected to the controller 83, and transmits a position signal of the intermediate hydraulic support to the controller 83 and the upper computer 82. The upper computer 82 stores a preset program, which can generate an instruction signal for the speed regulating valve 1 and the electro-hydraulic conversion module 716 according to the position signal of the intermediate hydraulic support, thereby realizing the control of the displacement of the hydraulic support.

According to a third aspect, an embodiment of the present application further provide an alignment method, which is implemented by the alignment system provided in the second aspect and includes: adjusting a relative rotation speed and displacement of the valve core and the valve base of the speed regulating valve provided in the first aspect, to adjust an opening speed, a closing speed, and/or an opening degree of the speed regulating valve to adjust a flow rate of emulsion, so as to adjust a position of the hydraulic support.

The adjustment of the position of the intermediate hydraulic support is fundamentally achieved by adjusting the volume of the emulsion flowing into the push hydraulic jack 712. Without considering the volume change of the emulsion, the position change of the intermediate hydraulic support is proportional to the volume of the emulsion introduced into the push hydraulic jack 712, so the position of the intermediate hydraulic support can be adjusted by adjusting the volume of the emulsion flowing through the speed regulating valve 1. Therefore, in the embodiments of the present application, the position of the intermediate hydraulic support can be adjusted by adjusting the flow rate of the emulsion by adjusting the opening speed, the closing speed, and/or the opening degree of the speed regulating valve 1.

Based on this, in order to precisely adjust the position of the intermediate hydraulic support, sensors are arranged on the two sides of the lifting hydraulic jacks 714 of the first hydraulic support 71 and the N^{th} hydraulic support 72, the sensors are arranged along the second direction, the sensors are at a same distance from the lifting hydraulic jack 714, and the sensors are used to determine relative positions of the intermediate hydraulic supports. Reference may also be made to the arrangement of the laser sensor 715 in the second aspect. In addition, referring to FIG. 3 a wireless laser displacement sensor 9 may further be arranged on each hydraulic support 7 to determine a displacement amount of the hydraulic support 7.

Specifically, the alignment method provided in the embodiment of the present application includes the following steps:

Step S01: A first alignment stage: The speed regulating valve 1 opens to a fully opened state at a first speed, a position of an n^{th} hydraulic support is adjusted, and when the position of the n^{th} hydraulic support is detected by the sensors, the speed regulating valve 1 closes to a fully closed state at the first speed, and the n^{th} hydraulic support stops at a first position, where 2≤n≤N−1.

Step S02: A second alignment stage: Position information of the first position is determined by the sensors, a second speed is generated by a controller 83 according to the position information of the first position, and the speed regulating valve 1 operates at the second speed to adjust the position of the n^{th} hydraulic support.

Step S03: The steps S01 to S02 are repeated, to adjust positions of a second hydraulic support to an (N−1)^{th} hydraulic support.

It should be noted that, in step S01, the n^{th} hydraulic support does not represent a particular hydraulic support, and is determined according to the adjustment process of multiple hydraulic supports of the alignment system. For example, when the second hydraulic support is adjusted, the n^{th} hydraulic support is the second hydraulic support; when the third hydraulic support is adjusted, the n^{th} hydraulic support is the third hydraulic support. For convenience of description, a straight line between the first hydraulic support 71 and the N^{th} hydraulic support is referred to as a reference straight line, and the hydraulic supports between the first hydraulic support 71 and the N^{th} hydraulic support are moved toward the reference straight line. For convenience of description, the hydraulic support being adjusted is referred to as a displacement hydraulic support 74.

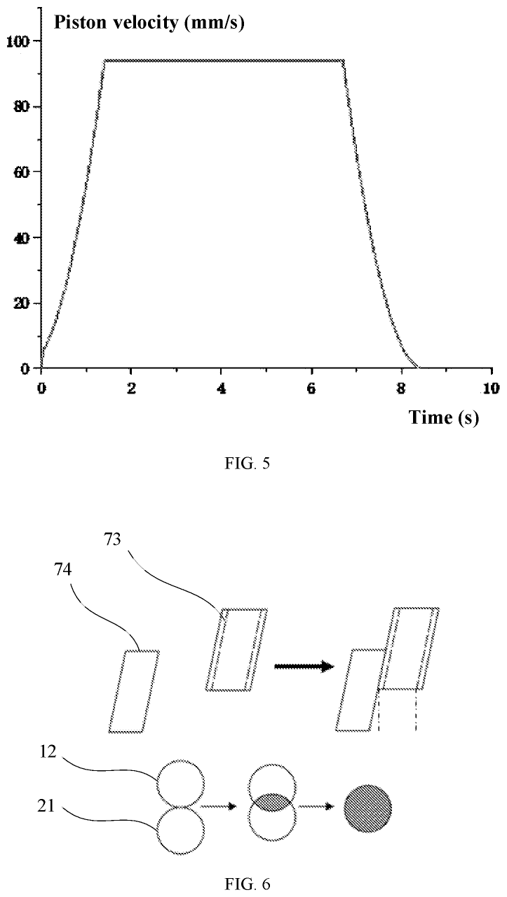

At the first alignment stage, the displacement hydraulic support 74 is far away from the reference straight line. In this case, the speed regulating valve 1 operates with a first parameter, to adjust the displacement hydraulic support 74. FIG. 5 is a schematic diagram of the first parameter, which shows a correspondence between the moving speed of the piston of the push hydraulic jack and time. In FIG. 5, curves at the beginning stage and the end stage indicate the opening and closing processes of the speed regulating valve, and the straight line at the intermediate stage indicates that the speed regulating valve 1 is in the fully opened state. The first alignment stage is an adjustment process with a high flow rate of the emulsion. The first parameter may be set according to adjustment experience. For example, referring to FIG. 5, the opening and closing speeds of the speed regulating valve 1 may be set, or the time during which the speed regulating valve 1 remains in the fully opened state may also be limited, so that the displacement hydraulic support 74 can be as close to the reference straight line as possible when the displacement hydraulic support 74 stops. FIG. 6 is a schematic diagram showing a relative position of a hydraulic support and an opening degree of the speed regulating valve 1 during the first alignment stage. The shaded part in FIG. 6 indicates an overlapping area of the first speed regulating port 22 and the second speed regulating port 31, that is, the shaded part indicates the opening degree of the valve.

It should be noted that after the first alignment stage is completed, the hydraulic support is already close to the reference straight line, but due to errors or pressure accumulation in the oil pipe, the position at which the displacement hydraulic support 74 stops cannot be determined. Therefore, no matter how the first parameter is set, it cannot be ensured that the displacement hydraulic support 74 can be adjusted to the position of the reference straight line. In this case, step S02 is carried out to perform second alignment stage on the hydraulic support.

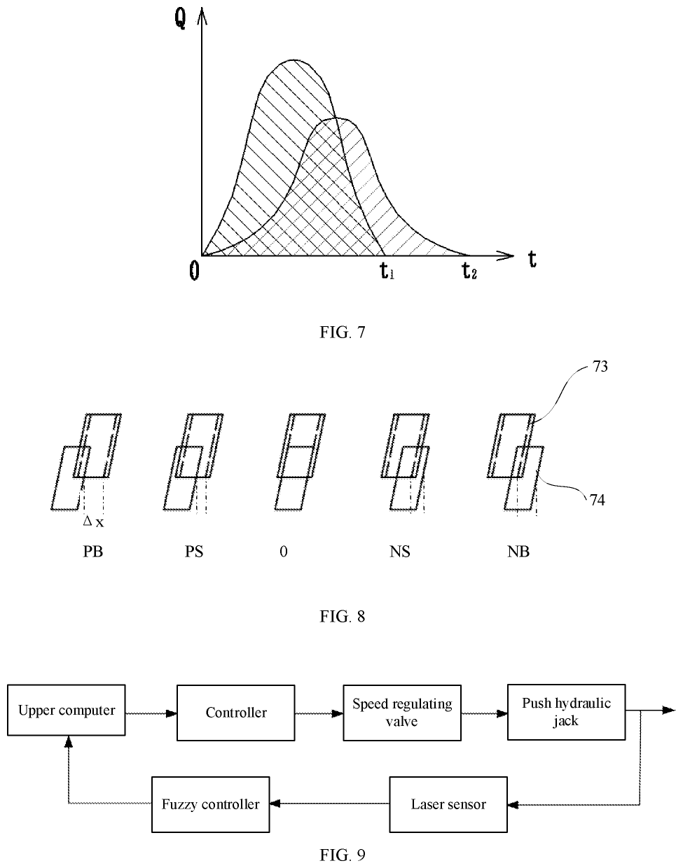

In step S02, the controller 83 is used to generate a second speed of the speed regulating valve 1 based on the first position of the n^{th} hydraulic support, and the speed regulating valve 1 operates at the second speed to adjust the position of the n^{th} hydraulic support. In other words, in step S02, the controller 83 can correspondingly generate the second speed according to the distance between the displacement hydraulic support 74 and the reference straight line, and the speed regulating valve 1 operates at the second speed to adjust the displacement hydraulic support 74 to a target position. FIG. 7 is a schematic diagram of adjusting a hydraulic support by the speed regulating valve 1 at the second speed. In FIG. 7, the curve corresponding to t₁ represents one possibility of the second speed, and the curve corresponding to t₂ represents another possibility of the second speed.

It should be noted that the controller 83 includes a fuzzy controller. The fuzzy controller can generate a control parameter for the speed regulating valve 1 according to a relative distance between the displacement hydraulic support 74 and the reference straight line. Fuzzy control is a logic process that simulates reasoning and decision-making, and can carry out simple artificial reasoning. For example, in the embodiments of the present application, when the displacement hydraulic support 74 is far away from the reference straight line, the fuzzy controller sends, to the speed regulating valve 1, an instruction of shifting the hydraulic support with a larger opening degree and a longer time; When the distance between the hydraulic support and the reference straight line is small, the fuzzy controller sends an instruction of shifting the hydraulic support with a smaller opening degree and a shorter time.

Five grades are defined according to deviations of the positions of the displacement hydraulic support 74 and the reference hydraulic support 73. The reference support is the first hydraulic support or the N^{th} hydraulic support 72. For convenience of description, the position deviation between the displacement hydraulic support 74 and the reference hydraulic support 73 is referred to as Δx, and Δx is classified into five grades. Correspondingly, five grades are also defined for the rotation angle ω of the valve core 2 of the speed regulating valve 1: negative large (NB), negative small (NS), zero (0), positive small (PS), and positive large (PB). FIG. 8 is a schematic diagram of five grades of Δx.
If Δx=NB, then ω=NB;
if Δx=NS, then ω=NS;
if Δx=0, then ω=0;
if Δx=PS, then ω=PS; and
if Δx=PB, then ω=PB.

For ease of distinguishing, the corresponding NB, NS, 0, PS and PB of Δx are labeled as NBe, NSe, 0e, PSe and PBe. NB, NS, 0, PS and PB corresponding to ω are labeled as NBu, NSu, 0u, PSu and PBu, and a fuzzy relationship R is:

$$R = ( NBe \times NBu ) ⋃ ( NSe \times NSu ) ⋃ ( 0 e \times 0 u ) ⋃ ( PSe \times PSu ) ⋃ ( PBe \times PBu )$$

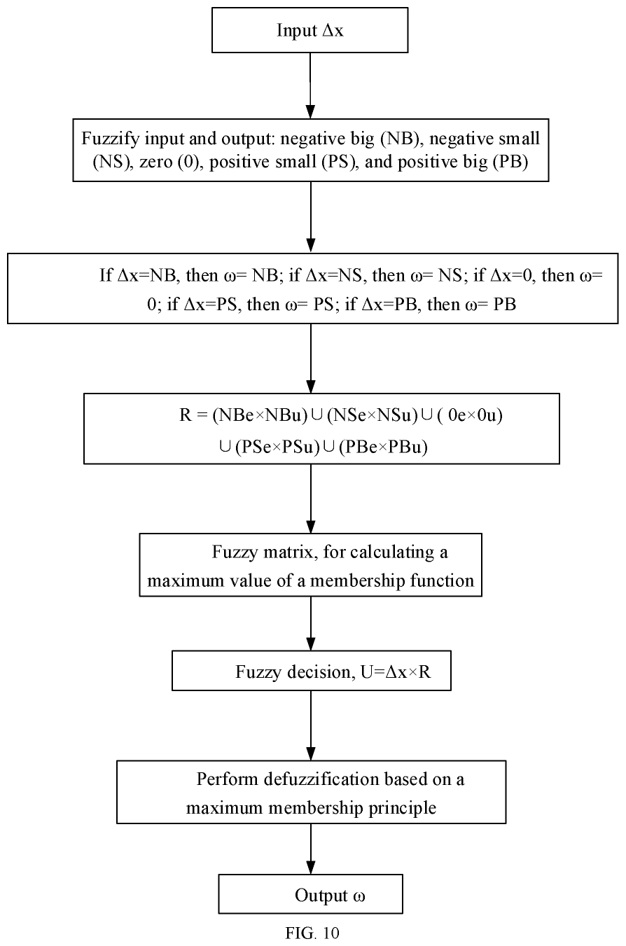

According to a fuzzy matrix, a maximum value of R is calculated, where U=Δx×R, where U represents a voltage signal. The controller 83 determines ω corresponding to Δx based on the value of the U. FIG. 9 is a schematic signal flowchart of the speed regulating valve 1. FIG. 10 is a schematic flowchart of a fuzzy controller.

The serial numbers of the embodiments of the present application are only for the purpose of description, and do not represent the preference for the embodiments. The above are only preferred embodiments of the present application, and therefore are not intended to limit the patent scope of the present application. Any equivalent structure or equivalent process transformation made based on the contents of the specification and drawings of the present application, or the direct or indirect application of the present application to other related technical fields are all included in the protection scope of the present application.

### INDUSTRIAL APPLICABILITY

Because the alignment method provided in the embodiment of the present application is implemented by using the alignment system provided in the second aspect, the same technical effect can be achieved: precisely controlling the flow rate of emulsion to precisely adjust the position of the hydraulic support, thereby reducing the impact of emulsion on the alignment system during adjustment.

What is claimed is:

1. A speed regulating valve, comprising:
a valve core, provided with an internal channel and in communication with an inlet of the speed regulating valve, wherein a first speed regulating port is arranged on the valve core; and
a valve base, in communication with an outlet of the speed regulating valve, wherein a second speed regulating port is arranged on the valve base;
wherein the valve core and the valve base are rotatable relative to each other, and the second speed regulating port is on a trajectory of a rotation of the first speed regulating port; and when the valve core and the valve base rotate relative to each other, the first speed regulating port and the second speed regulating port are gradually aligned to communicate the inlet and the outlet of the speed regulating valve; and
a fixed differential pressure reducing device is arranged between the inlet of the speed regulating valve and the valve core, the fixed differential pressure reducing device is provided with a sealing part, a first end of the sealing part is in communication with the inlet of the speed regulating valve, and a second end of the sealing part is in communication with the outlet of the speed regulating valve, to balance a pressure difference between the outlet and the inlet of the speed regulating valve.

2. The speed regulating valve according to claim 1, wherein the valve core is of a cylindrical structure, a hollow structure is arranged at one end of the valve core adjacent to the inlet of the speed regulating valve, a cylindrical cavity is arranged at a position of the valve base corresponding to the valve core, and the valve core is sheathed in the cylindrical cavity.

3. The speed regulating valve according to claim 2, wherein the first speed regulating port is a circular hole, and an axis of the first speed regulating port is perpendicular to an axis of the valve core.

4. The speed regulating valve according to claim 3, wherein a plurality of the first speed regulating ports are arranged, and the plurality of the first speed regulating ports are evenly distributed along a circumferential direction of the valve core.

5. The speed regulating valve according to claim 4, wherein when the valve core rotates along the valve base, only one of the plurality of the first speed regulating ports is in communication with the second speed regulating port.

6. The speed regulating valve according to claim 5, wherein a driving part is arranged at a position of the speed regulating valve corresponding to the valve core, and the driving part is in a transmission connection with the valve core to rotate the valve core.

7. (canceled)

8. An alignment system, comprising:
the speed regulating valve according to claim 1;
N hydraulic supports, wherein the N hydraulic supports are arranged and distributed along a first direction, N≥2, N is a positive integer, the hydraulic supports are provided with a pedestal, and a push hydraulic jack is arranged on one side of the pedestal along a second direction; and
an oil supply device, configured to provide an emulsion, and connected to the push hydraulic jack through the speed regulating valve.

9. The alignment system according to claim 8, wherein a top beam is arranged above the pedestal, lifting hydraulic jacks are arranged between the pedestal and the top beam, and laser sensors are arranged on two sides of the lifting hydraulic jacks of a first hydraulic support and an N^{th} hydraulic support.

10. The alignment system according to claim 9, wherein the laser sensors are arranged on the two sides of the lifting hydraulic jacks along the second direction and are at a same distance from the lifting hydraulic jacks.

11. The alignment system according to claim 10, wherein the laser sensors arranged on the first hydraulic support and the N^{th} hydraulic support are staggered along a third direction, wherein the laser sensors do not interfere with each other.

12. An alignment method, implemented by using the alignment system according to claim 8, and comprising: adjusting a relative rotation speed and displacement of the valve core and the valve base of the speed regulating valve according to claim 1, to adjust an opening speed, a closing speed, and/or an opening degree of the speed regulating valve to adjust a flow rate of the emulsion, to adjust a position of the hydraulic support.

13. The alignment method according to claim 12, wherein sensors are arranged on the two sides of the lifting hydraulic jacks of the first hydraulic support and the N^{th} hydraulic support, the sensors are arranged along the second direction, the sensors are at a same distance from the lifting hydraulic jacks, and the sensors are configured to determine relative positions of the hydraulic supports.

14. The alignment method according to claim 13, comprising the following steps:
step S01: a first alignment stage: opening the speed regulating valve to a fully opened state at a first speed, to adjust a position of an n^{th} hydraulic support, and when the position of the n^{th} hydraulic support is detected by the sensors, closing the speed regulating valve to a fully closed state at the first speed, to stop the n^{th} hydraulic support at a first position, wherein 2≤n≤N−1;
step S02: a second alignment stage: determining position information of the first position by the sensors, generating a second speed by a controller according to the position information of the first position, and allowing the speed regulating valve to operate at the second speed to adjust the position of the n^{th} hydraulic support; and
step S03: repeating the steps S01 to S02, to adjust positions of a second hydraulic support to an (N−1)^{th} hydraulic support.

15. The alignment system according to claim 8, wherein in the speed regulating valve, the valve core is of a cylindrical structure, a hollow structure is arranged at one end of the valve core adjacent to the inlet of the speed regulating valve, a cylindrical cavity is arranged at a position of the valve base corresponding to the valve core, and the valve core is sheathed in the cylindrical cavity.

16. The alignment system according to claim 15, wherein in the speed regulating valve, the first speed regulating port is a circular hole, and an axis of the first speed regulating port is perpendicular to an axis of the valve core.

17. The alignment system according to claim 16, wherein in the speed regulating valve, a plurality of the first speed regulating ports are arranged, and the plurality of the first speed regulating ports are evenly distributed along a circumferential direction of the valve core.

18. The alignment system according to claim 17, wherein in the speed regulating valve, when the valve core rotates along the valve base, only one of the plurality of the first speed regulating ports is in communication with the second speed regulating port.

19. The alignment system according to claim 18, wherein in the speed regulating valve, a driving part is arranged at a position of the speed regulating valve corresponding to the valve core, and the driving part is in a transmission connection with the valve core to rotate the valve core.

20. The alignment method according to claim 12, wherein in the alignment system, a top beam is arranged above the pedestal, lifting hydraulic jacks are arranged between the pedestal and the top beam, and laser sensors are arranged on two sides of the lifting hydraulic jacks of a first hydraulic support and an N^{th} hydraulic support.
